(19) United States
(12) Patent Application Publication
(10) Pub. No.: US 2015/0248771 A1
(43) Pub. Date: Sep. 3, 2015

(54) Apparatus and Method for Recognizing Lane

(71) Applicant: Core Logic, Inc., Seoul (KR)

(72) Inventor: ByungHo Kim, Suwon-si (KR)

(73) Assignee: Core Logic, Inc.

(21) Appl. No.: 14/318,442

(22) Filed: Jun. 27, 2014

(30) Foreign Application Priority Data
Feb. 28, 2014 (KR) 10-2014-0024568

(51) Int. Cl. G06T 7/00; G06T 5/40

(52) U.S. Cl. CPC G06T 7/0095; G06T 7/0083; G06T 5/40; G06T 2207/30256

(57) ABSTRACT

Disclosed is an apparatus and method for recognizing a lane, which may have a small amount of calculations and may improve rate, energy efficiency and accuracy in lane recognition by flexibly correcting an interested area. The apparatus for recognizing a lane includes a lane edge extracting unit for extracting an edge of a lane from a driving image of a vehicle, a lane detecting unit for drawing a linear functional formula between x and y, corresponding to the extracted edge of the lane, based on an X-Y coordinate system in which a horizontal axis of the driving image is an x-axis and a vertical axis is a y-axis, and a lane location analyzing unit for analyzing a location of the lane by using the drawn linear functional formula.

### CROSS-REFERENCE TO RELATED APPLICATION

The present application claims priority to Korean Patent Application No. 10-2014-0024568 filed on Feb. 28, 2014 in the Republic of Korea, the disclosures of which are incorporated herein by reference.

### BACKGROUND OF THE DISCLOSURE

1. Field of the Disclosure

The present disclosure relates to a lane recognition technique, and more particularly, to an apparatus and method for recognizing a lane rapidly and accurately from a vehicle driving image input through a camera sensor such as a vehicle black box.

2. Description of the Related Art

Recently, various devices are being introduced to a vehicle to enhance convenience of a driver and safety of a vehicle which is running. Among them, a system for recognizing a lane while a vehicle is running on a road and then providing a driver with driving-related information such as deviation from a lane, sensed from lane recognition information, is representative.

If a driving image is input through a camera sensor such as a black box, an existing lane recognition technique representatively uses Hough transformation to recognize a lane from the input image. In the Hough transformation, a lane in an X-Y coordinate system is converted into a θ-ρ coordinate system to detect the lane, thereby analyzing a location of the lane. This Hough transformation will be described in more detail with reference to FIG. 1.

FIG. 1 is a diagram for illustrating how to convert an X-Y coordinate system into a θ-ρ coordinate system according to an existing Hough transformation.

Referring to FIG. 1, a following equation may be established between the X-Y coordinate system and the θ-ρ coordinate system.

ρ=x cos θ+y sin θ

If a technique for detecting deviation from a lane according to the Hough transformation is used, a lane of the X-Y coordinate system is converted into the θ-ρ coordinate system to detect the lane. In other words, while changing θ and ρ, a line where an edge of the lane intersects with the equation is detected, thereby obtaining an equation of a lane in the θ-ρ coordinate system. In addition, in order to analyze a location of the detected lane, the θ-ρ coordinate system is inversely converted into the X-Y coordinate system (inverse Hough transformation) to obtain a location of the lane.

However, if the Hough transformation is used for recognizing a lane and analyzing a location of the lane, the Hough transformation and its inverse transformation should be performed, and many trigonometrical functions should be used, which requires a lot of calculations and thus results in a slow calculation rate. For this reason, in order to suitably deal with such a lot of calculations, a high-performance CPU is required, and power consumption also increases.

In addition, in a part of the existing lane recognition technique, in order to enhance a lane recognition rate, a specific partial area of an image input through a camera sensor is designated as an interested area, and a lane is detected within the interested area. However, in this technique, since the interested area is fixed, if an actual lane is out of the interested area, the actual lane may not be accurately detected, and unnecessary interested area may be excessively present according to a location of the lane, and thus there is a limit in enhancing accuracy and rate in lane recognition.

### SUMMARY OF THE DISCLOSURE

The present disclosure is designed to solve the problems of the related art, and therefore the present disclosure is directed to providing an apparatus and method for recognizing a lane, which may have a small amount of calculations and may improve rate, energy efficiency and accuracy in lane recognition by flexibly correcting an interested area.

Other objects and advantages of the present disclosure will be understood from the following descriptions and become apparent by the embodiments of the present disclosure. In addition, it is understood that the objects and advantages of the present disclosure may be implemented by components defined in the appended claims or their combinations.

In one aspect of the present disclosure, there is provided an apparatus for recognizing a lane, which includes a lane edge extracting unit for extracting an edge of a lane from a driving image of a vehicle; a lane detecting unit for drawing a linear functional formula between x and y, corresponding to the extracted edge of the lane, based on an X-Y coordinate system in which a horizontal axis of the driving image is an x-axis and a vertical axis is a y-axis; and a lane location analyzing unit for analyzing a location of the lane by using the drawn linear functional formula.

Preferably, the apparatus for recognizing a lane may further include an interested area setting unit for setting an interested area for the driving image by using the linear functional formula drawn by the lane detecting unit, and the lane edge extracting unit may extract an edge of the lane within the interested area set by the interested area setting unit.

Also preferably, when two linear functional formulas are drawn by the lane detecting unit, the interested area setting unit may calculate an intersection point of the two linear functional formulas as a vanishing point, and set the interested area by using the calculated vanishing point.

Also preferably, the interested area setting unit may set a y-axis coordinate value of the vanishing point as a y-axis coordinate upper limit of the interested area, search a y-axis coordinate value of a hood of the vehicle, and set the searched y-axis coordinate value of the hood as a y-axis coordinate lower limit of the interested area.

Also preferably, the interested area setting unit may correct a preset interested area by using a location of the vanishing point and width information of the road.

Also preferably, the lane detecting unit may draw a following equation as the linear functional formula between x and y:

x=a×(y−y_{b})+x_{d}

where x and y are variables, a is a constant representing a ratio of an increment of x to an increment of y, y_{b} represents a y-axis coordinate lower limit of the interested area, and x_{d} represents a x-axis coordinate value of the linear functional formula at a lower limit of the interested area.

Also preferably, the lane detecting unit may move a point t located at the upper limit of the interested area and a point d located at the lower limit of the interested area in a horizontal direction, respectively, and when a number of pixels overlapping with the lane edge extracted by the lane edge extracting unit is greatest, an equation between x and y for a line connecting the points t and d may be drawn as the linear functional formula.

Also preferably, the lane detecting unit may draw a following equation as the linear functional formula;

$$x = \frac{( {x}_{d} - {x}_{t} )}{( {y}_{b} - {y}_{v} )} \times ( y - {y}_{b} ) + {x}_{d}$$

where x and y are variables, xₜ and yᵥ represent an x-axis coordinate value and a y-axis coordinate value of the point t, and x_{d} and y_{b} represent an x-axis coordinate value and a y-axis coordinate value of the point d.

Also preferably, the apparatus for recognizing a lane may further include a lane extracting unit for generating an extracted lane image by at least partially removing an image out of the lane from the driving image of the vehicle, and the lane edge extracting unit may extract an edge of the lane from the extracted lane image.

Also preferably, the lane extracting unit may receive the driving image as a gray image, and generate the extracted lane image as a binary-coded image.

Also preferably, the lane extracting unit may include a road brightness calculating part for receiving the gray image to calculate a brightness threshold; a brightness-based filtering part for extracting only pixels having brightness over the brightness threshold from the gray image and generating a binary-coded image by using the extracted pixels; and a width-based filtering part for comparing widths of the pixels extracted by the brightness-based filtering part with a reference width range, and removing a pixel having a width out of the reference width range from the binary-coded image.

Also preferably, the road brightness calculating part may divide a portion corresponding to the road into a plurality of regions, calculate mean pixel brightness in each region, and calculate a brightness threshold based on the mean pixel brightness.

Also preferably, the width-based filtering part may calculate a ratio of a lane width to a road width, compare the calculated ratio with a reference ratio range, and remove a pixel whose ratio is out of the reference ratio range from the binary-coded image.

In another aspect of the present disclosure, there is also provided a method for recognizing a lane, which includes extracting an edge of a lane from a driving image of a vehicle; drawing a linear functional formula between x and y, corresponding to the extracted edge of the lane, based on an X-Y coordinate system in which a horizontal axis of the driving image is an x-axis and a vertical axis is a y-axis; and analyzing a location of the lane by using the drawn linear functional formula.

In an aspect of the present disclosure, since an amount of calculations in a lane recognition process is small, a calculation rate may be improved in comparison to an existing technique.

In particular, if the present disclosure is used, in an X-Y coordinate system, a linear functional formula between x and y is used to recognize a lane, and Hough transformation and inverse Hough transformation using trigonometrical functions may not be used, different from the existing technique.

Therefore, in this aspect of the present disclosure, a lane recognition rate may be effectively improved, and power consumption for calculations is not so great, thereby improving energy efficiency. In addition, in this aspect of the present disclosure, since a high-performance CPU is not required, a manufacture cost may be reduced. In particular, in order to implement the present disclosure, a general-purpose CPU may be used, and further a floating point unit (FPU) included in such a general-purpose CPU may also be used, which may enhance a calculation rate.

In addition, in an aspect of the present disclosure, in a vehicle driving image input through a camera sensor such as a black box, an interested area serving as an effective area for recognizing a lane is not fixed, and the interested area may be corrected depending on situations.

Therefore, in this aspect of the present disclosure, even though a view angle or installation position of a camera is changed like a detachable image photographing device or various road situations such as a road curvature or a road width are changed, the interested area may be flexibly corrected, thereby enhancing accuracy in lane recognition and reducing an amount of calculations.

### BRIEF DESCRIPTION OF THE DRAWINGS

The accompanying drawings illustrate preferred embodiments of the present disclosure and, together with the foregoing disclosure, serve to provide further understanding of the technical spirit of the present disclosure. However, the present disclosure is not to be construed as being limited to the drawings. In the drawings:

FIG. 1 is a diagram for illustrating how to convert an X-Y coordinate system into a θ-ρ coordinate system according to an existing Hough transformation;

FIG. 2 is a block diagram schematically showing a functional configuration of an apparatus for recognizing a lane (hereinafter, also referred to as a “lane recognizing apparatus”) according to an embodiment of the present disclosure;

FIG. 3 is a diagram showing an example of a driving image photographed by an image photographing device;

FIG. 4 is a diagram schematically showing an image where an edge of a lane is extracted according to an embodiment of the present disclosure;

FIG. 5 is a diagram schematically showing a process of drawing a linear functional formula corresponding to a lane edge detected by a lane detecting unit on the X-Y coordinate system;

FIG. 6 is a diagram schematically showing an interested area set for a driving image according to an embodiment of the present disclosure;

FIG. 7 is a diagram schematically showing a process of drawing a linear functional formula corresponding to a lane in an interested area of a driving image according to an embodiment of the present disclosure;

FIG. 8 is a diagram schematically showing a process of correcting an interested area according to an embodiment of the present disclosure;

FIG. 9 is a block diagram schematically showing a functional configuration of a lane extracting unit according to an embodiment of the present disclosure;

FIG. 10 is a diagram schematically showing a process of calculating a brightness threshold by a road brightness calculating part according to an embodiment of the present disclosure; and

FIG. 11 is a flowchart for illustrating a method for recognizing a lane according to an embodiment of the present disclosure.

### DESCRIPTION OF THE PREFERRED EMBODIMENT

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the spirit and scope of the disclosure.

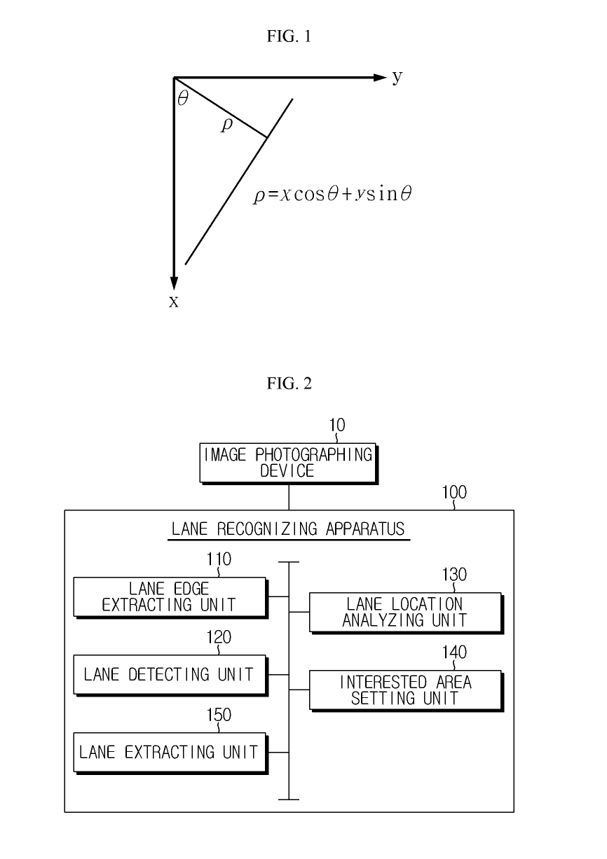

FIG. 2 is a block diagram schematically showing a functional configuration of an apparatus 100 for recognizing a lane (hereinafter, also referred to as a “lane recognizing apparatus”) according to an embodiment of the present disclosure;

Referring to FIG. 2, the lane recognizing apparatus 100 according to the present disclosure includes a lane edge extracting unit 110, a lane detecting unit 120 and a lane location analyzing unit 130.

In the specification, the term “lane” generally means various lines representing a running direction of a vehicle, and may include not only a traffic lane for distinguishing paths of vehicles running on the same road in the same direction, such as a first lane, a second lane or the like, but also other kinds of lanes such as a centerline, a shoulder line, a line for limiting the change of course, a U-turn line, an exclusive lane, a guide lane or the like.

The lane recognizing apparatus according to the present disclosure may use a driving image photographed by an image photographing device 10 in order to implement its function. In other words, the image photographing device 10 may photograph a vehicle driving image, and provide the photographed driving image to the lane recognizing apparatus.

FIG. 3 is a diagram showing an example of a driving image photographed by the image photographing device 10.

As shown in FIG. 3, the image photographing device 10 is an element having a camera sensor capable of photographing a vehicle driving image, and a representative example of the image photographing device 10 is a vehicle black box. However, the present disclosure is not limited to a specific example of the image photographing device, and various devices capable of photographing an image may be used as the image photographing device. For example, an existing vehicle black box and other devices capable of photographing an image such as a cellular phone, a notebook, a tablet PC or the like may be used as the image photographing device.

Meanwhile, even though FIG. 2 shows as if the image photographing device is not included in the lane recognizing apparatus of the present disclosure, the image photographing device may also be included as a component of the lane recognizing apparatus according to the present disclosure. For example, the lane recognizing apparatus according to the present disclosure may include an image photographing unit and directly photograph a driving image, used for recognizing a lane, by using the image photographing unit.

The lane edge extracting unit 110 may extract an edge of a lane from the driving image photographed by the image photographing device.

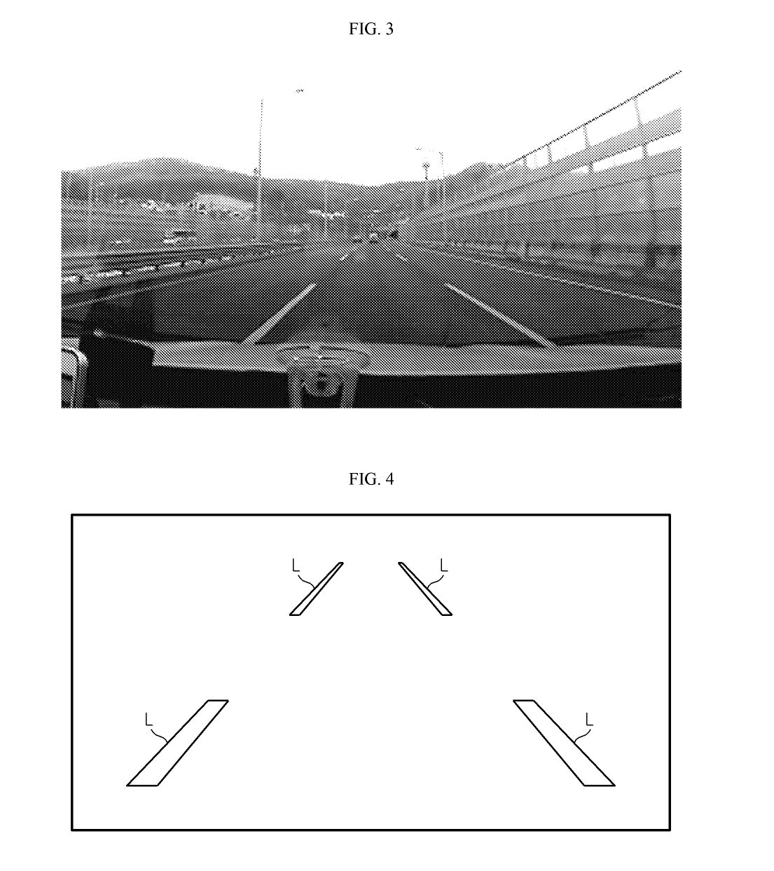

FIG. 4 is a diagram schematically showing an image from which an edge of a lane is extracted according to an embodiment of the present disclosure.

Referring to FIG. 4, as indicated by L, the lane edge extracting unit 110 may extract edges of a lane included in the driving image. Generally, a lane has a rectangular shape with four sides, and each lane may be configured with edges including a left side, a right side, an upper side and a lower side. Therefore, the lane edge extracting unit 110 may extract a left line, a right line, an upper line and a lower line as edges of the lane. However, if the lane is a solid line, the lane edge extracting unit 110 may also extract only a left line and a right line as edges of the lane for a predetermined time.

In particular, the lane edge extracting unit 110 may extract edges of a lane by means of a canny algorithm. However, the present disclosure is not limited to this embodiment, and the lane edge extracting unit 110 may extract edges of a lane in various ways.

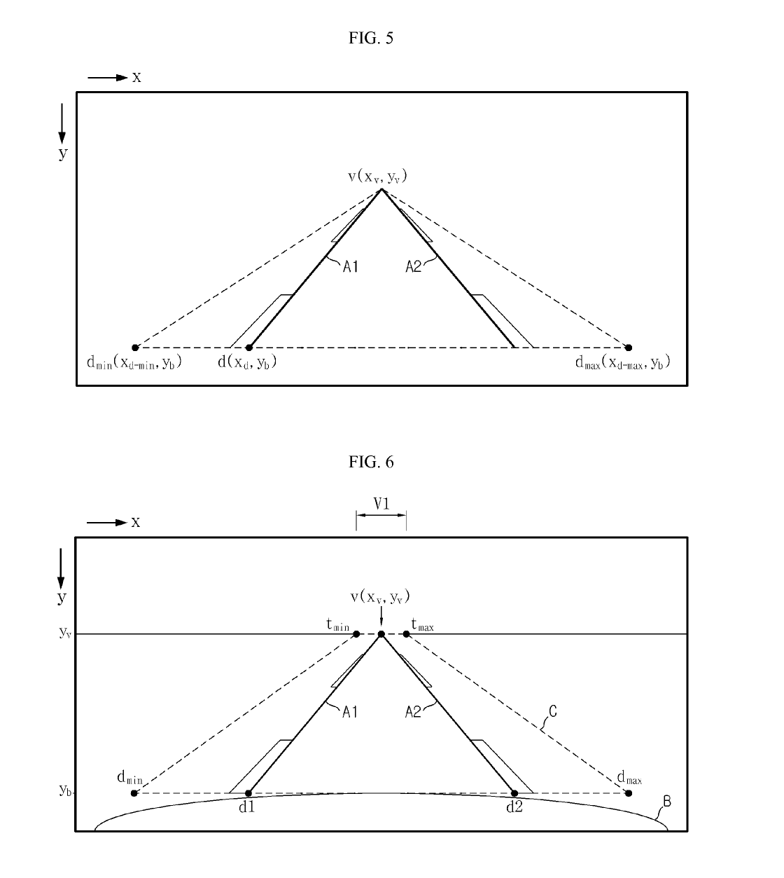

The lane detecting unit 120 may draw a linear functional formula between x and y corresponding to the lane edge extracted by the lane edge extracting unit 110, based on an X-Y coordinate system with respect to the driving image. A process of drawing a formula for a lane by the lane detecting unit 120 will be described in more detail below with reference to FIG. 5.

FIG. 5 is a diagram schematically showing a process of drawing a linear functional formula corresponding to a lane edge detected by the lane detecting unit 120 on the X-Y coordinate system.

Referring to FIG. 5, if an edge of a lane is extracted from a vehicle driving image by the lane edge extracting unit 110, the lane detecting unit 120 may draw a formula for a lane edge on the X-Y coordinate system by using the image from which the lane edge is extracted.

In other words, a location of each pixel in the driving image may be explained on the X-Y coordinate system in which a horizontal axis is an x-axis and a vertical axis is a y-axis. At this time, an origin point where the x-axis and y-axis intersect may be at a left top point of the driving image as shown in FIG. 5.

The lane detecting unit 120 may draw a linear functional formula between x and y corresponding to the lane edge based on the X-Y coordinate system with respect to the driving image. Here, since the linear functional formula represents a straight line on the X-Y coordinate system, the lane detecting unit 120 may be regarded as drawing a straight line corresponding to the lane edge.

At this time, the lane detecting unit 120 may draw a straight line corresponding to an inner line among edges of a lane. Here, the inner line means a line close to a vertical center axis of a vehicle with respect a single lane. For example, the inner line may be a right line based on a left lane edge, and the inner line may also be a left line based on a right lane edge.

In particular, the lane detecting unit 120 may draw a formula about a straight line having a greatest amount of pixels overlapping with the extracted lane edge in the lane image as a linear functional formula corresponding to the lane edge.

For example, in the embodiment of FIG. 5, the lane detecting unit 120 may figure out a straight line A1 having a greatest amount of pixels overlapping with an edge of a left lane as a straight line corresponding to the left lane in the driving image. In addition, the lane detecting unit 120 may draw a formula corresponding to the straight line A1 as a linear functional formula corresponding to the left lane.

At this time, the lane detecting unit 120 may draw the linear functional formula corresponding to the left lane by using Equation 1 below on the X-Y coordinate system of FIG. 5.

x=a×(y−y_{b})+x_{d} Equation 1

where x and y are variables on the X-Y coordinate system, a represents a slope of the straight line A1, and x_{d} and y_{b} represent a coordinate of an arbitrary point d.

Meanwhile, the lane detecting unit 120 may figure out a straight line A2 having a greatest amount of pixels overlapping with an edge of a right lane, as a straight line corresponding to the right lane in the driving image. In addition, the lane detecting unit 120 may a formula corresponding to the straight line A2 as a linear functional formula corresponding to the right lane.

Here, the slope a of Equation 1 may be expressed as follows using two points v(xᵥ, yᵥ) and d(x_{d}, y_{b}) on the X-Y coordinate system.

$$a = \frac{( {x}_{d} - {x}_{v} )}{( {y}_{b} - {y}_{v} )} \qquad Equation 2$$

Therefore, if Equation 2 is applied to Equation 1, Equation 1 may be arranged as follows.

$$x = \frac{( {x}_{d} - {x}_{v} )}{( {y}_{b} - {y}_{v} )} \times ( y - {y}_{b} ) + {x}_{d} \qquad Equation 3$$

Equation 3 may be regarded as expressing Equation 1 with locations of two points (the point v and the point d) on the X-Y coordinate system.

Meanwhile, as shown in FIG. 5, the point v(xᵥ, yᵥ) may be an intersection point between the straight line A1 corresponding to the left lane and the straight line A2 corresponding to the right lane, and in this case, the intersection point v may be regarded as corresponding to a vanishing point of the driving image. In addition, since the lane projected on the image converges to the vanishing point, the lane detecting unit 120 may use the vanishing point when drawing a linear functional formula corresponding to the lane afterwards. In other words, the lane detecting unit 120 may find a straight line corresponding to the left lane and its linear functional formula, while changing a slope of the straight line A1 based on the vanishing point v. In addition, the lane detecting unit 120 may find a straight line corresponding to the right lane and its linear functional formula, while changing a slope of the straight line A2 based on the vanishing point v.

The lane location analyzing unit 130 analyzes a location of the lane by using the linear functional formula drawn by the lane detecting unit 120. In particular, the lane location analyzing unit 130 may analyze a point on the straight line corresponding to the lane as a location of the lane.

For example, in the embodiment of FIG. 5, the lane location analyzing unit 130 may recognize any one point on the straight line corresponding to the left lane, for example x_{d} which is an x coordinate of the point d based on the point d whose y coordinate is y_{b}, as a location of the lane.

The lane location analyzing unit 130 may recognize a location of the left lane and a location of the right lane separately. In addition, from the locations of the left lane and the right lane, a width of the road may be obtained. At this time, the lane location analyzing unit 130 compares the obtained width of the road with a reference road width. If the width of the road is smaller than the reference value, the lane location analyzing unit 130 may determine that a road mark or the like other than a lane is erroneously recognized as a lane, and notify this to another component, for example the lane detecting unit 120 or the like.

In addition, if it is determined that the analyzed location of the lane is at a center of the road and the lane has a slope close to a vertical direction, the lane location analyzing unit 130 may determine that a road mark other than a lane is erroneously recognized as a lane.

Preferably, the lane recognizing apparatus may further include an interested area setting unit 140 as shown in FIG. 2.

The interested area setting unit 140 sets an interested area in a driving image. Here, the interested area may be regarded as meaning an effective area for recognizing a lane is from the driving image. Therefore, areas of the driving image other than the interested area may be regarded as non-interested areas, namely areas from which a lane is not to be recognized.

Therefore, in this configuration of the present disclosure, a lane is recognized only within an effective interested area, which may reduce an amount of calculations.

In particular, in the present disclosure, if a linear functional formula corresponding to a lane is drawn by the lane detecting unit 120, the interested area setting unit 140 may set an interested area for the driving image by using the linear functional formula.

If so, other components of the lane recognizing apparatus, for example the lane edge extracting unit 110, the lane detecting unit 120 and the lane location analyzing unit 130, may operate based on the set interested area.

FIG. 6 is a diagram schematically showing an interested area set for a driving image according to an embodiment of the present disclosure.

Referring to FIG. 6, the interested area setting unit 140 may set a region marked by a dotted line C in the driving image as the interested area. If so, the lane edge extracting unit 110 may extract an edge of only a lane included in the interested area marked by the dotted line C from the driving image.

In this configuration of the present disclosure, since a lane edge is extracted only within the interested area of the driving image, it is possible to improve a rate and accuracy of lane edge extracting operation and reduce a load applied to the lane recognizing apparatus.

In particular, the interested area set by the interested area setting unit 140 may have an upper limit and a lower limit and may also have a trapezoidal shape in consideration of a perspective feeling.

Preferably, if the lane detecting unit 120 draws two linear functional formulas, the interested area setting unit 140 may an intersection point of the two linear functional formulas as a vanishing point and set an interested area by using the calculated vanishing point.

For example, as shown in FIG. 6, the driving image may have a left lane and a right lane based on a vehicle, and the left lane and the right lane may converge to the vanishing point. Therefore, a formula of a straight line A1 corresponding to the left lane and a formula of a straight line A2 corresponding to the right lane may have different slopes and intersect at an intersection point v(xᵥ, yᵥ). At this time, the intersection point v may be regarded as a vanishing point of the driving image. Therefore, the interested area setting unit 140 may consider an intersection point of linear functional formulas for two straight lines corresponding to the left lane and the right lane as a vanishing point and then set an interested area by using the vanishing point.

In particular, the interested area setting unit 140 may set a y-axis coordinate value of the vanishing point v as a y-axis coordinate upper limit of the interested area. In other words, in the embodiment of FIG. 6, since the y-axis coordinate value of the vanishing point v is yᵥ, yᵥ may be set as the y-axis coordinate upper limit of the interested area. Here, the y-axis coordinate upper limit of the interested area may be a y-axis coordinate value for an upper limit of the interested area in the driving image. Therefore, the upper limit of the interested area may also be a part of the straight line y=yᵥ.

Meanwhile, the interested area setting unit 140 may set a point tₘᵢₙ and a tₘₐₓ respectively spaced apart from the vanishing point in a right and left horizontal direction as much as predetermined pixels (distance), namely as much as indicated by v1 in FIG. 6, as a left limit and a right limit of the interested area. The left limit and the right limit for the upper limit of the interested area may be regarded as margins in consideration of the possibility of change of the vanishing point in a next image.

In addition, the interested area setting unit 140 may recognize a hood of the vehicle, searches a y-axis coordinate value of the recognized hood and set the searched y-axis coordinate value of the hood as a y-axis coordinate lower limit of the interested area. In other words, as indicated by B in the embodiment of FIG. 6, a driving image photographed by the image photographing device such as a black box may include a hood, and the interested area setting unit 140 may set a y-axis coordinate value y_{b} located at an uppermost portion of the hood as a y-axis coordinate lower limit of the interested area. In this case, the lower limit of the interested area may be a part of the straight line y=y_{b}.

Here, the interested area setting unit 140 may detect a y-axis location y_{b} of the hood by using a horizontal edge extracting algorithm. In particular, in order to improve a hood recognizing speed, the interested area setting unit 140 may search a hook in a lower direction from a point spaced apart downwards from the vanishing point as much as predetermined pixels.

However, a hood may also not be included in an image according to a vertical installation angle of the camera sensor or if the vehicle is a truck, and in this case, the interested area setting unit 140 may not search a hood. If a hood is not searched, the interested area setting unit 140 may set a portion located below the vanishing point by a predetermined distance or a portion above the lower end of the image by a predetermined distance as a lower limit of the interested area in consideration of a vertical image angle of the camera. Like this, the lower limit of the interested area may be determined in various ways.

Meanwhile, as shown in FIG. 6, the interested area setting unit 140 may set a left limit dₘᵢₙ of the lower limit of the interested area so that the left limit of the interested area is located at a left side of the road, and may set a right limit dₘₐₓ of the lower limit of the interested area so that the right limit of the interested area is located at a right side of the road.

For example, as shown in FIG. 6, if it is assumed that an intersection point between the lower limit of the interested area and a straight line corresponding to the left lane is d1 and an intersection point between the lower limit of the interested area and a straight line corresponding to the right lane is d2, the interested area setting unit 140 may receive coordinate information of the points d1 and d2 from the lane location analyzing unit 130. If so, the interested area setting unit 140 may set a point dₘᵢₙ spaced apart from the point d1 in a left direction as much as predetermined pixels as a left limit of the lower limit of the interested area and set a point dₘₐₓ spaced apart from the point d2 in a right direction as much as predetermined pixels as a right limit of the lower limit of the interested area.

Meanwhile, information about a vanishing point and a lane may not be present in an initial operating stage of the system. In addition, even though there is present information about a vanishing point and a lane, this information may include erroneous or wrong data. In this case, the interested area setting unit 140 may set the interested area on the assumption that the vanishing point is present at an arbitrary position in the driving image. In particular, the interested area setting unit 140 may assume that the vanishing point is present at the center of the image. In this case, the interested area setting unit 140 may search a location of a hood from a point spaced apart from the assumed vanishing point in a lower direction by using a horizontal edge extracting algorithm. In addition, the interested area setting unit 140 may set the interested area in a way similar to the above by using the assumed vanishing point and the searched location of the hood.

Preferably, the interested area setting unit 140 may correct a preset interested area. In other words, the interested area setting unit 140 may correct an interested area which is set arbitrarily or based on information obtained by a previous driving image. At this time, the interested area setting unit 140 may use a location of the vanishing point and a width of the road in order to correct the interested area, as described later.

If the interested area is set, or corrected, by the interested area setting unit 140 as described above, each component of the lane recognizing apparatus may operate based on the interested area.

For example, the lane recognizing apparatus may extract a lane edge only from an image within the interested area, draw a linear functional formula between x and y corresponding to the extracted lane edge, and analyze a location of the lane therefrom.

In particular, the lane detecting unit 120 may detect a lane while changing a slope of a linear function converging to the vanishing point. For example, if the vanishing point is determined as v(xᵥ, yᵥ) in a previous image as in the embodiment of FIG. 5, the lane detecting unit 120 may detect straight lines respectively corresponding to a left lane and a right lane by placing a straight line so that its one end is fixed to the point v with respect to a next driving image and moving the other end of the straight line along the lower limit of the interested area. In other words, while moving the point d(x_{d}, y_{b}) which is the other end of the straight line from the point dₘᵢₙ to the point dₘₐₓ, the lane detecting unit 120 may detect a straight line closest to the lane, and draw a linear functional formula of the detected straight line.

At this time, the linear functional formula of the straight line conforming to the lane may be equal to Equation 1.

In other words, the lane detecting unit 120 may draw the following equation as a linear functional formula between x and y corresponding to a lane edge.

x=a×(y−y_{b})+x_{d}

Here, x and y are variables, a is a constant representing a ratio of an increment of x to an increment of y, y_{b} represents a y-axis coordinate lower limit of the interested area, and x_{d} represents a x-axis coordinate value of the linear functional formula at the lower limit of the interested area. In particular, x_{d} and y_{b} may be an x coordinate and a y coordinate of the intersection point where the lower limit of the interested area intersects a straight line corresponding to the lane.

Meanwhile, in the linear functional formula corresponding to a lane as in Equation 1, a is as defined in Equation 2. Therefore, the lane detecting unit 120 may express the linear functional formula corresponding to a lane in a form like Equation 3.

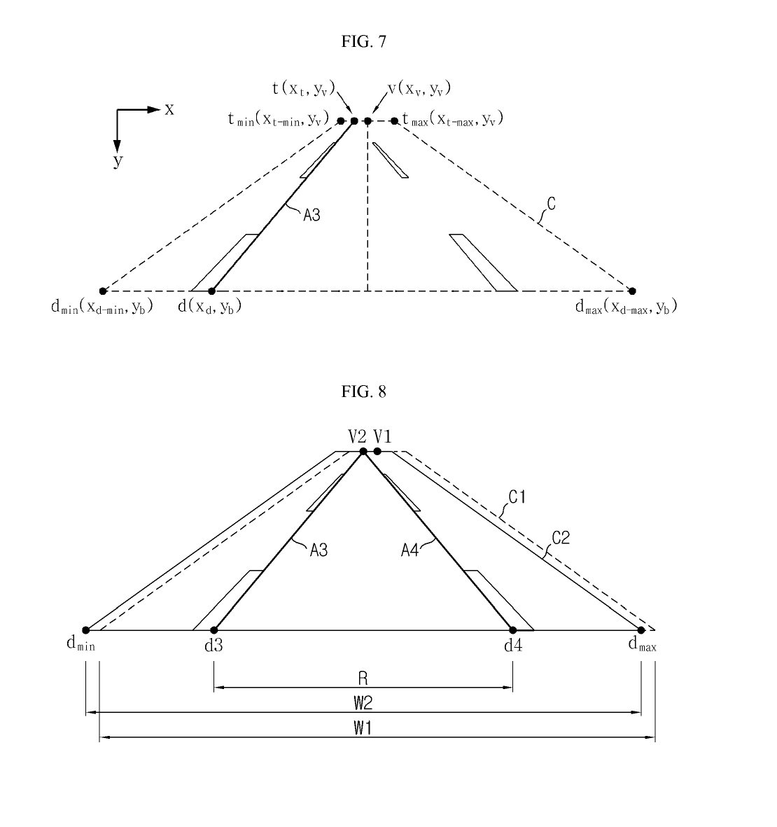

More preferably, in order to draw a linear functional formula corresponding to a lane, the lane detecting unit 120 may be configured to extract a straight line closest to the lane while moving one end of a straight line corresponding to the linear functional formula in a right and left direction within the upper limit of the interested area and moving the other end of the straight line in a right and left direction within the lower limit of the interested area. This will be described in more detail below with reference to FIG. 7.

FIG. 7 is a diagram schematically showing a process of drawing a linear functional formula corresponding to a lane in an interested area of a driving image according to an embodiment of the present disclosure.

Referring to FIG. 7, an interested area C is set for the driving image, and an edge is displayed only for a lane included in the interested area. The interested area may be set by the interested area setting unit 140, and the interested area setting unit 140 may set the interested area based on a vanishing point v(xᵥ, yᵥ) and a lane extracted from a previous driving image.

In the embodiment of FIG. 7, a y coordinate of the upper limit of the interested area is yᵥ, a left limit of the upper limit is expressed as tₘᵢₙ (xₜ₋ₘᵢₙ, yᵥ), and a right limit of the upper limit is expressed as tₘₐₓ (xₜ₋ₘₐₓ, yᵥ). In addition, a y coordinate of the lower limit of the interested area is y_{b}, a left limit of the lower limit is expressed as dₘᵢₙ (x_{d-min}, y_{b}), and a right limit of the lower limit is expressed as dₘₐₓ (x_{d-max}, y_{b}).

In this circumstance, while moving a point t located on the upper limit of the interested area and a point d located on the lower limit of the interested area in a horizontal direction, respectively, the lane detecting unit 120 may draw a formula of a straight line connecting the point t and the point d and having a greatest amount of pixels on the lane edge as a linear functional formula corresponding to the lane. In other words, the lane detecting unit 120 may draw a linear functional formula of a straight line A3 corresponding to the lane while moving the point t between the point tₘᵢₙ and the point tₘₐₓ and moving the point d between the point dₘᵢₙ and the point dₘₐₓ.

Here, based on the embodiment of FIG. 7, the lane detecting unit 120 may draw a linear functional formula corresponding to the lane as follows.

$$x = \frac{( {x}_{d} - {x}_{t} )}{( {y}_{b} - {y}_{v} )} \times ( y - {y}_{b} ) + {x}_{d} \qquad Equation 4$$

where x and y are variables, xₜ and yᵥ represent an x-axis coordinate value and a y-axis coordinate value of the point t, and x_{d} and y_{b} represent an x-axis coordinate value and a y-axis coordinate value of the point d.

Meanwhile, as described above, when drawing a linear functional formula corresponding to a lane, the lane detecting unit 120 may refer to a number of pixels overlapping with the lane edge. In other words, the lane detecting unit 120 may regard a straight line having a greatest number of pixels overlapping with the lane edge as a straight line corresponding to the lane, and draw a formula for the straight line as a linear functional formula corresponding to the lane.

Here, the lane detecting unit 120 may set a lane detection threshold in relation to the number of pixels overlapping with the lane edge. Therefore, even though a straight line has a greatest number of pixels overlapping with the lane edge, if the number of pixels overlapping with the lane edge does not exceed the lane detection threshold, the lane detecting unit 120 may regard that the straight lane is not a straight line corresponding to the lane and thus the lane is not detected. In addition, if many lane formulas exceeding the lane detection threshold are detected, the lane detecting unit 120 may regard that noise is detected, and newly detect a lane.

At this time, the lane detecting unit 120 may set the lane detection threshold in proportion to a height of the interested area. For example, in the embodiment of FIG. 7, the interested area may be y_{b}-yᵥ. Here, the lane detecting unit 120 may set the lane detection threshold in proportion to the interested area. For example, the lane detecting unit 120 may set the lane detection threshold relatively higher when the interested area has a greater height.

Meanwhile, the lane detecting unit 120 may draw two linear functional formulas like Equation 4. In other words, as shown in FIG. 7, within the interested area of the driving image, two lanes, namely a left lane and a right lane, are generally present based on the vehicle. Therefore, while moving the point t and the point d, the lane detecting unit 120 may draw a linear functional formula corresponding to the left lane and a linear functional formula corresponding to right lane, respectively. In this case, the lane detecting unit 120 may divide the interested area into a left interested area and a right interested area based on the line x=xᵥ, then find a single linear functional formula corresponding to the left lane in the left interested area, and find a single linear functional formula corresponding to the right lane in the right interested area.

The lane location analyzing unit 130 may analyze a location of a lane by using the interested area set by the interested area setting unit 140. In particular, the lane location analyzing unit 130 may analyze a point where the lane formula detected by the lane detecting unit 120 intersects the lower limit of the interested area set by the interested area setting unit 140 as a location of the lane. For example, in the embodiment of FIG. 7, the lane location analyzing unit 130 may regard a point d where the straight line corresponding to the lane meets the lower limit of the interested area as a location of the lane.

Meanwhile, as described above, the interested area setting unit 140 may correct an interested area set previously. Therefore, if two linear functional formulas are drawn as described above, the interested area setting unit 140 may regard an intersection point between the two drawn functions as a vanishing point, and correct the interested area based on the vanishing point. This will be described in more detail below with reference to FIG. 8.

FIG. 8 is a diagram schematically showing a process of correcting an interested area according to an embodiment of the present disclosure.

Referring to FIG. 8, a region marked by a dotted line C1 represents a preset interested area based on a predetermined vanishing point v1. The lane recognizing apparatus may operate based on the interested area C1. At this time, the lane recognizing apparatus may extract lane edges and recognize straight lines corresponding thereto as A3 and A4 as indicated by FIG. 8.

If so, the interested area setting unit 140 regards an intersection point v2 of two straight lines A3 and A4 as a new vanishing point, and sets a new interested area based on the vanishing point v2 to correct an existing interested area. In other words, as indicated by a solid line C2 in FIG. 8, the interested area setting unit 140 may set a new interested area C2, different from the preset interested area C1. In addition, the interested area C2 newly set by the interested area setting unit 140 as described above may be used as an interested area for recognizing a lane in a driving image which is input later.

In addition, the interested area setting unit 140 may correct the interested area by using width information of the road.

For example, in the embodiment of FIG. 8, if straight lines A3 and A4 are detected by the lane detecting unit 120, a distance between the lines A3 and A4 in the lower limit of the interested area C1 may be a width of the road, expressed as R. At this time, if the width R of the road is different from a width of the road when the interested area C1 is determined before, the interested area setting unit 140 may adjust a width of the lower limit of the interested area. For example, if the newly recognized width R of the road is greater than a previous width of the road, the interested area setting unit 140 may set the interested area C2 so that a width W2 of the lower limit of the interested area C2 is greater than a width W1 of the lower limit of the interested area C1.

In addition, the interested area setting unit 140 may correct the interested area in consideration of the location of the lane, analyzed by the lane location analyzing unit 130. For example, in the embodiment of FIG. 8, the interested area setting unit 140 may determine a location of the left limit dₘᵢₙ of the lower limit, based on a point d3 where the straight line A3 meets the lower limit of the interested area. For example, when the point d3 moves to the left in comparison to a previous image, the interested area setting unit 140 may also move the point dₘᵢₙ to the left and set a new interested area C2. At this time, the interested area setting unit 140 may determine a moving distance of the point dₘᵢₙ, based on the moving distance of the point d3. In addition, the interested area setting unit 140 may determine a location of the right limit dₘₐₓ of the lower limit, based on a point d4 where the straight line A4 meets the lower limit of the interested area.

If the interested area may be corrected by the interested area setting unit 140 as in this embodiment, when a view angle or installation position of a camera is changed like a detachable image photographing device, when a width of a road is changed, or when a vanishing point is changed due to a curvature of the road or a rotation of the vehicle, the interested area may be flexibly corrected. Therefore, in this aspect of the present disclosure, the interested area may be optimally maintained suitable for various environments, and thus it is possible to reduce an amount of calculations for recognizing a lane and improve a rate and accuracy for the calculation work.

Preferably, the lane recognizing apparatus according to the present disclosure may further include a lane extracting unit 150 as shown in FIG. 2.

If a vehicle driving image is photographed by the image photographing device as shown in FIG. 2 the lane extracting unit 150 receives the photographed vehicle driving image from the image photographing device. In addition, the lane extracting unit 150 removes an image out of the lane at least partially from the input driving image to extract a lane.

Therefore, the lane extracting unit 150 may generate an extracted lane image in which a lane is extracted from the driving image. However, this extracted lane image may include other kinds of marks such as road marks and vehicle lights.

If the extracted lane image is generated by the lane extracting unit 150 as described above, other components of the lane recognizing apparatus may perform their functions based on the extracted lane image. For example, the lane edge extracting unit 110 may extract an edge from the lane extracted from the extracted lane image, and the lane detecting unit 120 may draw a linear functional formula corresponding to the extracted lane.

Preferably, the lane extracting unit 150 may receive the vehicle driving image as a gray-level image. In addition, the lane extracting unit 150 may generate the extracted lane image as a binary-coded image. For example, the lane extracting unit 150 may make a binary-coded image by removing an image other than the lane from a gray image input from the image photographing device, and provide the binary-coded image to the lane edge extracting unit 110. If so, the lane edge extracting unit 110 may extract a lane edge from the binary-coded image.

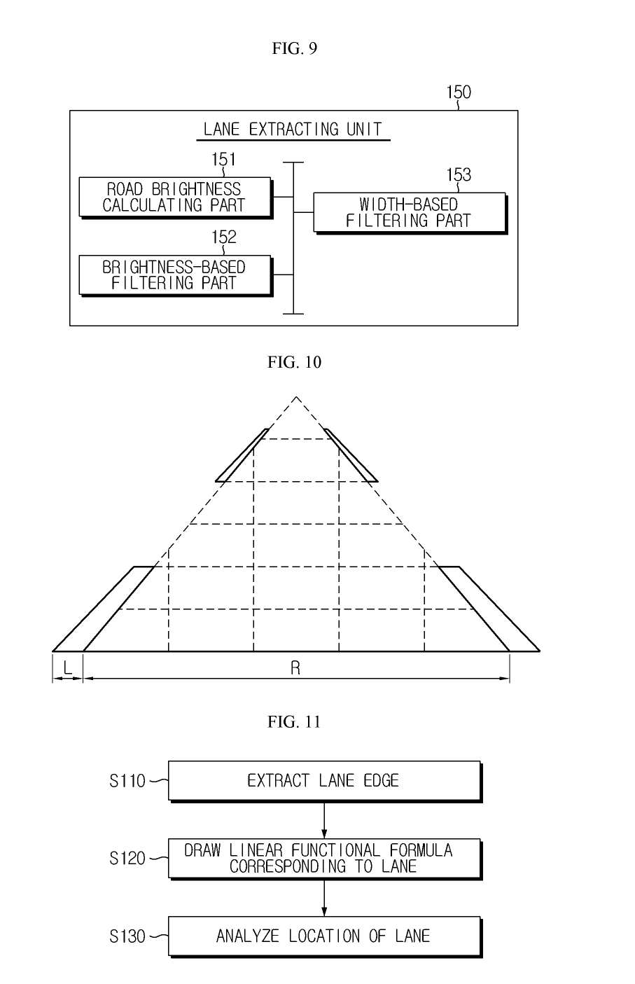

FIG. 9 is a block diagram schematically showing a functional configuration of the lane extracting unit 150 according to an embodiment of the present disclosure.

Referring to FIG. 9, the lane extracting unit 150 may include a road brightness calculating part 151, a brightness-based filtering part 152 and a width-based filtering part 153.

The road brightness calculating part 151 may calculate a brightness threshold by receiving a driving image from the image photographing device. In particular, the road brightness calculating part 151 may receive a gray image from the image photographing device, calculate mean brightness of a region corresponding to a road surface such as asphalt, and calculate a brightness threshold based on the brightness. At this time, it may be determined whether it is a road surface or not, based on a predetermined region of the driving image or information input from another component of the lane recognizing apparatus.

FIG. 10 is a diagram schematically showing a process of calculating a brightness threshold by the road brightness calculating part 151 according to an embodiment of the present disclosure.

Referring to FIG. 10, the road brightness calculating part 151 may designate a portion corresponding to a road, as indicated by R, as a plurality of regions in the gray image. In other words, the road brightness calculating part 151 may divide a portion corresponding to the road other than lanes indicated by L into a plurality of block regions. In addition, the road brightness calculating part 151 may calculate mean pixel brightness in each region, and calculate a brightness threshold of a pixel corresponding to the lane or the road surface based on the calculated pixel brightness. For example, the road brightness calculating part 151 may calculate brightness greater than the mean pixel brightness, which corresponds to asphalt, by a predetermined level as a brightness threshold in each block. This configuration of the present disclosure may be strong against shade on the road and other noise. Meanwhile, the road brightness calculating part 151 may receive lane information recognized by the lane detecting unit 120 or the lane location analyzing unit 130 in a previous stage and designate a portion corresponding to the road as a block.

The brightness-based filtering part 152 may remove noise other than the road, based on the pixel brightness. In particular, the brightness-based filtering part 152 may remove marks other than the lane by using the brightness threshold calculated by the road brightness calculating part 151. For example, the brightness-based filtering part 152 may extract only pixels having brightness over the brightness threshold, from the gray image input from the image photographing device, and generate a binary-coded image by using the extracted pixels.

Here, the brightness-based filtering part 152 extracts pixels having brightness over the brightness threshold calculated by the road brightness calculating part 151, but the brightness-based filtering part 152 may remove any pixel having brightness excessively greater than the brightness threshold from the binary-coded image. At this time, the brightness threshold may be a maximum value of the brightness which may be regarded as representing a lane on a road. Therefore, a pixel having brightness excessively greater than the lane brightness is highly likely to be a pixel representing a light source such as a headlight or taillight of a vehicle, or surrounding buildings. Therefore, in order to distinguish the lane from such light sources, the brightness-based filtering part 152 regards that a pixel having brightness excessively greater than the brightness threshold is not a pixel representing a lane, and removes such a pixel from the binary-coded image.

For example, the brightness-based filtering part 152 may designate brightness higher than the brightness threshold by a predetermined level as a light source threshold, and remove a pixel over the light source threshold from pixels displayed in the binary-coded image. In this case, the brightness-based filtering part 152 may generate a binary-coded image by extracting only pixels having brightness between the brightness threshold and the light source threshold.

Preferably, the road brightness calculating part 151 may adjust the brightness threshold based on information fed back from another component of the lane recognizing apparatus.

For example, when information notifying that a lane is not detected is received from the lane detecting unit 120, the road brightness calculating part 151 may set the brightness threshold to be lower than a previous stage. In other case, when information notifying that noise over a normal level is recognized is received, the road brightness calculating part 151 may set the brightness threshold to be higher than a previous stage.

The width-based filtering part 153 may remove noise other than the lane based on a width, with respect to the pixels extracted by the brightness-based filtering part 152. As described above, since the brightness-based filtering part 152 generates a binary-coded image for pixels extracted based on brightness, the generated binary-coded image may include pixels not only for the lane but also various road marks other than the lane. The width-based filtering part 153 may remove various marks other than the lane from the binary-coded image as noise.

For example, a left turn mark, a right turn mark, a U-turn mark, a speed limit mark, various guide signs or the like may be included in a road as roam marks in addition to lane marks. Road marks other than lane marks may have brightness similar to the lane marks, and thus such road marks other than lane marks may not be removed by the brightness-based filtering part 152. Therefore, the width-based filtering part 153 may distinguish lane marks from other road marks based on a width of each road mark in the pixels included in the binary-coded image.

In particular, for the binary-coded image in which only specific pixels are extracted by the brightness-based filtering part 152, the width-based filtering part 153 may remove a pixel for a mark having a width greater than or smaller than a predetermined level, among the marks included in the binary-coded image. In other words, the width-based filtering part 153 may compare a width of a pixel extracted by the brightness-based filtering part 152 with a reference width range, and remove a pixel having a width out of the range not to be displayed in the binary-coded image.

For example, if the reference width range is set to be 20 to 30, the width-based filtering part 153 may determine a road sign having a width smaller than 20 or greater than 30 as a noise, which is not a lane, and determine a pixel for the road sign from the binary-coded image.

Preferably, the width-based filtering part 153 may distinguish a lane from other road marks based on a ratio of a lane width to a road width. In other words, the width-based filtering part 153 may calculate a ratio of a lane width to a road width, compare the calculated ratio with a reference ratio range, and remove a pixel corresponding to a mark having a ratio out of the reference ratio range from the binary-coded image. Here, the reference ratio range may be set based on, for example, “Manual for installation and management of traffic road marks by the National Police Agency”.

Meanwhile, the interested area setting unit 140 may provide interested area information to the lane extracting unit 150, and the lane extracting unit 150 may extract a lane within the interested area to enhance a lane extracting rate. In addition, the lane extracting unit 150 may receive information whether a lane is detected or whether noise is detected from the lane detecting unit 120, thereby improving an accuracy of lane extraction.

In addition, the lane recognizing apparatus according to an embodiment of the present disclosure may recognize various kinds of lanes distinguishably. General road marks may be classified into a centerline, a general lane, a shoulder line, a line for limiting the change of course, a U-turn line, an exclusive lane, a guide lane or the like. In addition, lanes may be classified into a broken line, a solid line, a double line or the like. Such lanes may have different colored lengths, vacant lengths, widths, colors or the like. Therefore, for example, the lane detecting unit 120 of the lane recognizing apparatus may store relevant information in advance and distinguish kinds of detected lanes.

In particular, the lane detecting unit 120 may recognize a centerline, distinguishably from a general lane. For example, a centerline may be a solid line having a width of 15 to 20 cm, and a general lane may have a width of 10 to 15 cm. In this case, the lane detecting unit 120 may distinguish whether the detected lane is a centerline or a general lane in consideration of the width of the lane edge.

In this configuration of the present disclosure, since the kind of lane is distinguished and then corresponding information is provided to a lane deviation determining and warning device or the like, the possibility of big accident may be greatly lowered. For example, since a traffic accident caused by a vehicle invading a centerline may give a great damage in comparison to a traffic accident caused by a vehicle invading a general lane, if it is possible to distinguish whether a recognized lane is a centerline or a general lane as in the above embodiment, a more critical alarm may be generated when the vehicle invades the centerline.

In addition, in a lane recognizing apparatus according to another embodiment of the present disclosure, a solid line and a broken line may be distinguishably recognized. For example, the lane detecting unit 120 may distinguish whether a recognized lane is a solid line or a broken line, based on the number of pixels of a straight line corresponding to a lane, which overlap with a lane edge.

Generally, a broken line allows a vehicle to change lanes depending on the situation, for example when overtaking, but a solid line does not allow a vehicle to change lanes in many cases. Therefore, if it is distinguished whether the lane recognized by the lane detecting unit 120 is a broken line or a solid line as described above, a more critical alarm may be generated when the vehicle invades a solid line.

Operations of the lane recognizing apparatus according to the present disclosure will be described.

For example, when a vehicle starts running and the lane recognizing apparatus also starts operating, an interested area may be initially set, if there is no interested area set before.

Since there may be no information about a vanishing point and a lane at an initial stage, in this case, the lane recognizing apparatus searches the entire image to detect lanes and a vanishing point. In other case, if it is determined that there is no information about a lane and a vanishing point as described above or there is information which is however erroneous, the lane recognizing apparatus may assume that the vanishing point is present at the center of the image.

In addition, the lane recognizing apparatus may search a location of a hood from a point spaced apart downwards from the assumed or detected vanishing point as much as predetermined pixels by using a horizontal edge detecting algorithm. If a hood is not detected, the lane recognizing apparatus may regard that a hood is not photographed in the image.

In addition, the lane recognizing apparatus may detect a lane based on the assumed or detected vanishing point. At this time, if a lane is not detected, the lane recognizing apparatus may repeat a process of assuming a vanishing point and detecting a lane for neighboring pixels.

If two lanes at both sides of a vehicle are not entirely detected even though the entire image is searched, the lane recognizing apparatus may regard that the vehicle is not on a running lane and stand by for a predetermined time. However, if two lanes at both sides are entirely detected, the lane recognizing apparatus may calculate an intersection point between a linear functional formula for the left lane and a linear functional formula for the right lane as a vanishing point. Next, the lane recognizing apparatus may set an interested area by using the calculated vanishing point and locations of the detected lane and hood, and apply the set interested area to a present image and/or a next image.

After that, the lane recognizing apparatus may extract a candidate lane from an image within the interested area, and draw a linear functional formula corresponding to the candidate lane for the image within the interested area to analyze a location of the lane. At this time, the analyzed location information of the lane may be used for correcting the interested area, and the corrected interested area may be applied to a present image frame and/or a next image frame.

Meanwhile, the lane recognizing apparatus according to the present disclosure may be implemented in various device forms. For example, the lane recognizing apparatus may be configured to be implemented in a black box or a navigation device equipped in a vehicle. In this case, the black box or navigation device may include the lane recognizing apparatus according to the present disclosure.

FIG. 11 is a flowchart for illustrating a method for recognizing a lane according to an embodiment of the present disclosure. In FIG. 11, a subject performing each step may be regarded as a component of the lane recognizing apparatus.

As shown in FIG. 11, in a method for recognizing a lane according to the present disclosure, first, an edge of a lane is extracted from a vehicle driving image photographed by the image photographing device (S110). After that, based on the X-Y coordinate system in which a horizontal axis of the driving image is an x-axis and a vertical axis is a y-axis, a linear functional formula between x and y corresponding to the extracted lane edge is drawn (S120). After that, a location of the lane is analyzed using the drawn linear functional formula (S130).

Preferably, before Steps S110 or S120, a setting step of, for example, correcting an interested area, may be further included. In this case, Steps S110 and S120 may be performed based on the set interested area.

The present disclosure has been described in detail. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

Meanwhile, even though this specification uses the term ‘unit’ for components such as the ‘lane edge extracting unit’, the ‘lane detecting unit’, the ‘lane location analyzing unit’, the ‘interested area setting unit’ or the like and also uses the term ‘part’ for components such as the ‘road brightness calculating part’, the ‘brightness-based filtering part’, the ‘width-based filtering part’ or the like, they are just used for expressing logic components and do not represent components which must be physically dividable or physically divided, as obvious to those skilled in the art.

In other words, in the present disclosure, each component corresponds to a logic element for implementing the technical spirit of the present disclosure, and thus even though some components are integrated or any component is divided, this should be interpreted as falling within the scope of the present disclosure as long as the function performed by the logic component of the present disclosure can be realized. In addition, if any component performs a similar or identical function, this should be interpreted as falling within the scope of the present disclosure regardless of the consistency of its name.

### REFERENCE SYMBOLS

10: image photographing device
100: apparatus for recognizing a lane
110: lane edge extracting unit
120: lane detecting unit
130: lane location analyzing unit
140: interested area setting unit
150: lane extracting unit
151: road brightness calculating part
152: brightness-based filtering part
153: width-based filtering part

What is claimed is:

1. An apparatus for recognizing a lane, comprising:
a lane edge extracting unit for extracting an edge of a lane from a driving image of a vehicle;
a lane detecting unit for drawing a linear functional formula between x and y, corresponding to the extracted edge of the lane, based on an X-Y coordinate system in which a horizontal axis of the driving image is an x-axis and a vertical axis is a y-axis; and
a lane location analyzing unit for analyzing a location of the lane by using the drawn linear functional formula.

2. The apparatus for recognizing a lane according to claim 1, further comprising:
an interested area setting unit for setting an interested area for the driving image by using the linear functional formula drawn by the lane detecting unit,
wherein the lane edge extracting unit extracts an edge of the lane within the interested area set by the interested area setting unit.

3. The apparatus for recognizing a lane according to claim 2,
wherein when two linear functional formulas are drawn by the lane detecting unit, the interested area setting unit calculates an intersection point of the two linear functional formulas as a vanishing point, and sets the interested area by using the calculated vanishing point.

4. The apparatus for recognizing a lane according to claim 3,
wherein the interested area setting unit sets a y-axis coordinate value of the vanishing point as a y-axis coordinate upper limit of the interested area, searches a y-axis coordinate value of a hood of the vehicle, and sets the searched y-axis coordinate value of the hood as a y-axis coordinate lower limit of the interested area.

5. The apparatus for recognizing a lane according to claim 3,
wherein the interested area setting unit corrects a preset interested area by using a location of the vanishing point and width information of the road.

6. The apparatus for recognizing a lane according to claim 2,
wherein the lane detecting unit draws a following equation as the linear functional formula between x and y:
x=a×(y−y_{b})+x_{d}
where x and y are variables, a is a constant representing a ratio of an increment of x to an increment of y, y_{b} represents a y-axis coordinate lower limit of the interested area, and x_{d} represents a x-axis coordinate value of the linear functional formula at a lower limit of the interested area.

7. The apparatus for recognizing a lane according to claim 6,
wherein the lane detecting unit moves a point t located at the upper limit of the interested area and a point d located at the lower limit of the interested area in a horizontal direction, respectively, and when a number of pixels overlapping with the lane edge extracted by the lane edge extracting unit is greatest, an equation between x and y for a line connecting the points t and d is drawn as the linear functional formula.

8. The apparatus for recognizing a lane according to claim 7,
wherein the lane detecting unit draws a following equation as the linear functional formula;
$$x = \frac{( {x}_{d} - {x}_{t} )}{( {y}_{b} - {y}_{v} )} \times ( y - {y}_{b} ) + {x}_{d}$$
where x and y are variables, x_{t and y}ᵥ represent an x-axis coordinate value and a y-axis coordinate value of the point t, and x_{d} and y_{b} represent an x-axis coordinate value and a y-axis coordinate value of the point d.

9. The apparatus for recognizing a lane according to claim 1, further comprising a lane extracting unit for generating an extracted lane image by at least partially removing an image out of the lane from the driving image of the vehicle,
wherein the lane edge extracting unit extracts an edge of the lane in the extracted lane image.

10. The apparatus for recognizing a lane according to claim 9,
wherein the lane extracting unit receives the driving image as a gray image, and generates the extracted lane image as a binary-coded image.

11. The apparatus for recognizing a lane according to claim 10, wherein the lane extracting unit includes:
a road brightness calculating part for receiving the gray image to calculate a brightness threshold;
a brightness-based filtering part for extracting only pixels having brightness over the brightness threshold from the gray image and generating a binary-coded image by using the extracted pixels; and
a width-based filtering part for comparing widths of the pixels extracted by the brightness-based filtering part with a reference width range, and removing a pixel having a width out of the reference width range from the binary-coded image.

12. The apparatus for recognizing a lane according to claim 11,
wherein the road brightness calculating part divides a portion corresponding to the road into a plurality of regions, calculates mean pixel brightness in each region, and calculates a brightness threshold based on the mean pixel brightness.

13. The apparatus for recognizing a lane according to claim 11,
wherein the width-based filtering part calculates a ratio of a lane width to a road width, compares the calculated ratio with a reference ratio range, and removes a pixel whose ratio is out of the reference ratio range from the binary-coded image.

14. A method for recognizing a lane, comprising:
extracting an edge of a lane from a driving image of a vehicle;
drawing a linear functional formula between x and y, corresponding to the extracted edge of the lane, based on an X-Y coordinate system in which a horizontal axis of the driving image is an x-axis and a vertical axis is a y-axis; and
analyzing a location of the lane by using the drawn linear functional formula.
